(19) United States
(12) Patent Application Publication
(10) Pub. No.: US 2017/0246696 A1
(43) Pub. Date: Aug. 31, 2017

(54) POSITIONING DEVICE FOR DRILLING TOOLS OF VARIOUS SIZES

(71) Applicant: Hangzhou Xiaoshan Johnson Tools Co., Ltd., Hangzhou City (CN)

(72) Inventor: Johnson HE, Hangzhou City (CN)

(21) Appl. No.: 15/054,961

(22) Filed: Feb. 26, 2016

(51) Int. Cl. B23B 49/02

(52) U.S. Cl. CPC B23B 49/026; B23B 2250/12

(57) ABSTRACT

A positioning device for drilling tools of various sizes contains: a body and an accommodation case. The body includes an inserting portion with at least one positioning structure configured to insert drilling tools of various sizes. The body also includes at least one mounting set configured to mount the body on a working face, an inlet defined on a top thereof, and a channel defined in a bottom thereof and communicating with the inlet and the inserting portion. The accommodation case is configured to accommodate coolant and includes an outlet formed on a first end thereof and an air hole arranged on a second end thereof. Between the accommodation case and the body is defined a connection structure configured to connect the accommodation case with the elongated plate and to align the outlet of the accommodation case with the inlet of the body.

### FIELD OF THE INVENTION

The present invention relates to a positioning device for drilling tools of various sizes in which coolant flows into a channel of a pad from an accommodation case via an outlet and an inlet of an elongated plate and feeds into a second groove from the channel so as to cool the drilling tools quickly.

### BACKGROUND OF THE INVENTION

A conventional positioning device is disclosed in U.S. 2010/0236753A1, U.S. 2008/0219785A1, and FR 2924959 and assists a drilling tool drill to drill at least one opening, but the drilling tool cannot be cooled quickly. Another conventional positioning device is disclosed in GB 2444240 and is mounted on a drilling tool, yet a feeding pipe is connected with an accommodating container in which coolant is accommodated, thus causing using inconvenience.

The present invention has arisen to mitigate and/or obviate the afore-described disadvantages.

### SUMMARY OF THE INVENTION

The primary objective of the present invention is to provide a positioning device for drilling tools of various sizes in which coolant flows into a channel of a pad from an accommodation case via an outlet and an inlet of an elongated plate and feeds into a second groove from the channel so as to cool the drilling tools quickly.

Another objective of the present invention is to provide a positioning device for drilling tools of various sizes in which the accommodation case has an engagement protrusion fixed on a peripheral side thereof so as to engage with two locking recesses of the elongated plate, and when the accommodation case is in connection with the elongated plate, a connection size of a body and the accommodation case reduces, thus storing the body and the accommodation case easily.

To obtain above-mentioned objectives, a positioning device for drilling tools of various sizes provided by the present invention contains: a body and an accommodation case.

The body includes an inserting portion with at least one positioning structure configured to insert drilling tools of various sizes. The body also includes at least one mounting set configured to mount the body on a working face, an inlet defined on a top thereof, and a channel defined in a bottom thereof and communicating with the inlet and the inserting portion.

The accommodation case is configured to accommodate coolant and includes an outlet formed on a first end thereof and an air hole arranged on a second end thereof.

Between the accommodation case and the body is defined a connection structure configured to connect the accommodation case with the elongated plate and to align the outlet of the accommodation case with the inlet of the body.

### BRIEF DESCRIPTION OF THE DRAWINGS

FIG. 1 is a perspective view showing the exploded components of a positioning device for drilling tools of various sizes according to a first embodiment of the present invention.

FIG. 2 is a perspective view showing the assembly of the positioning device for the drilling tools of various sizes according to the first embodiment of the present invention.

FIG. 3 is a cross sectional view showing the assembly of the positioning device for the drilling tools of various sizes according to the first embodiment of the present invention.

FIG. 4 is a perspective view showing the application of the positioning device for the drilling tools of various sizes according to the first embodiment of the present invention.

FIG. 5 is a cross sectional view showing the application of the positioning device for the drilling tools of various sizes according to the first embodiment of the present invention.

FIG. 6 is another perspective view showing the application of a positioning device for drilling tools of various sizes according to a second embodiment of the present invention.

FIG. 7 is a side plane view showing the application of the positioning device for the drilling tools of various sizes according to the second embodiment of the present invention.

FIG. 8 is a cross sectional view of FIG. 7.

FIG. 9 is a perspective view showing the operation of the positioning device for the drilling tools of various sizes according to the second embodiment of the present invention.

### DETAILED DESCRIPTION OF THE PREFERRED EMBODIMENTS

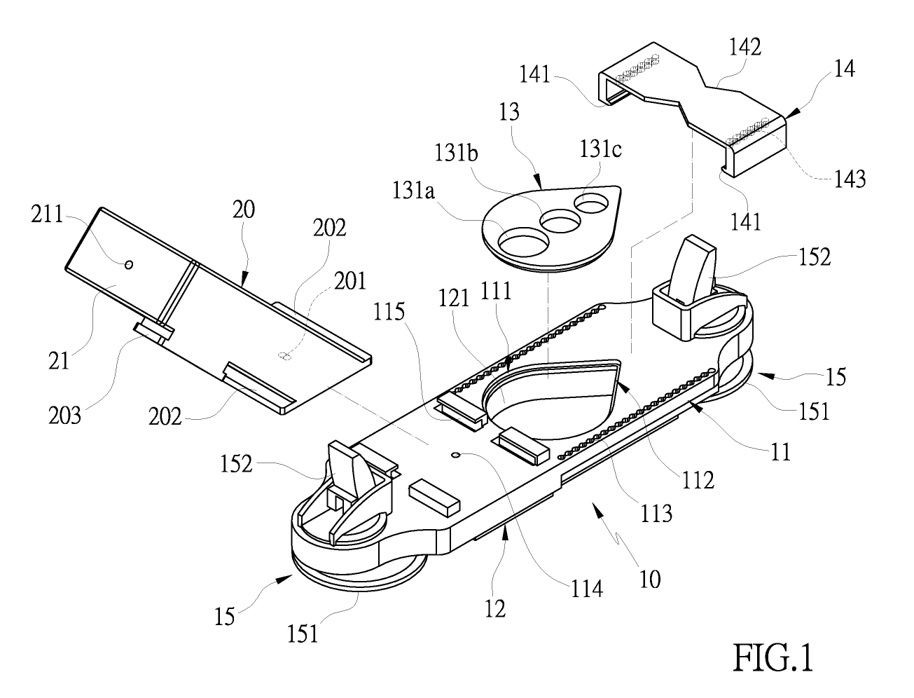

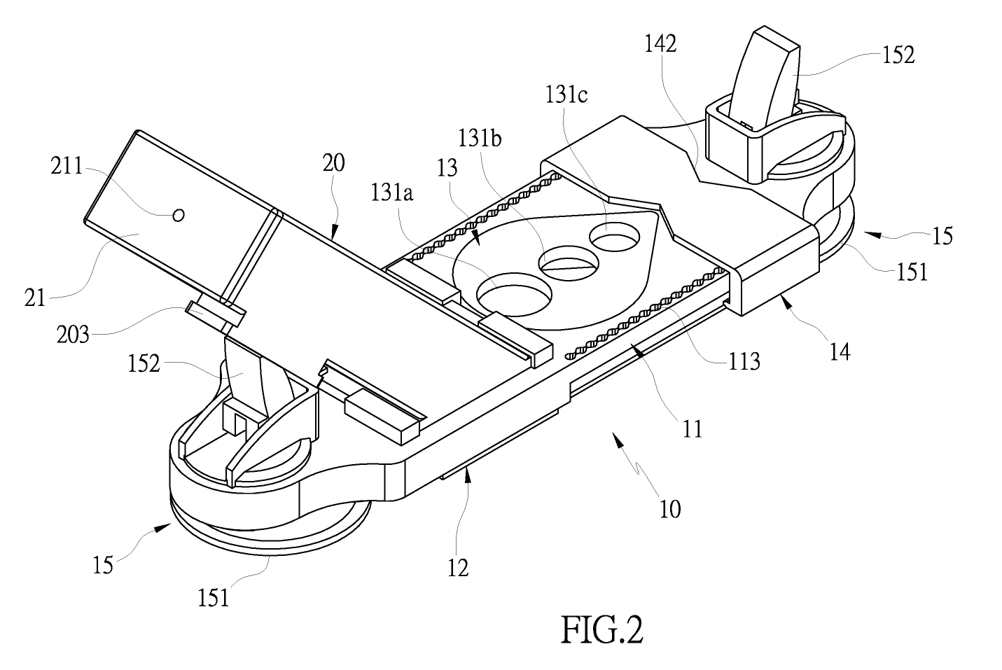

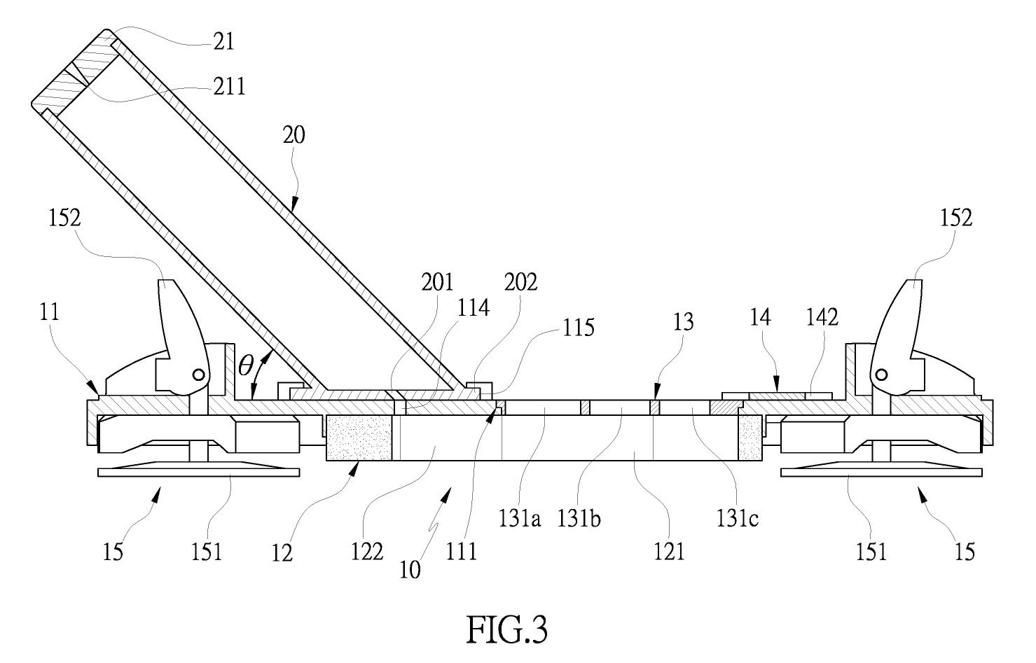

With reference to FIGS. 1 to 3, a positioning device for drilling tools of various sizes according to a first embodiment of the present invention comprises: a body 10 and an accommodation case 20. The body 10 includes an elongated plate 11 and a pad 12 disposed on a bottom of the elongated plate 11 and made of foam or rubber. The elongated plate 11 has a first groove 11 defined on a central position thereof, and the pad 12 has a second groove 121 for corresponding to the first groove 111 of the elongated plate 11, such that between the first groove 111 of the elongated plate 11 and the second groove 121 of the pad 12 defines an inserting portion so as to insert drilling tools of various sizes. The inserting portion of the body 10 includes at least one positioning structure configured to position the drilling tools. In this embodiment, the inserting portion includes a first positioning structure and a second positioning structure which are configured to position the drilling tools of various sizes, wherein the first positioning structure includes a fixing piece 13 housed in the first groove 111 of the elongated plate 11, and the fixing piece 13 has plural locating orifices 131a, 131b, and 131c which correspond to the drilling tools of various sizes. The second positioning structure includes a first affix fringe 112 formed in a V shape and around a peripheral side of the first groove 111 of the elongated plate 11, and the elongated plate 11 also has an adjusting member 14 mounted on a top thereof, wherein the adjusting member 14 has two hooking portions 143, each hooking portion 143 is arranged on each of two sides of the adjusting member 14 so as to hook each of two sides of the elongated plate 11 of the body 10, hence the adjusting member 14 is adjustably moved on the top of the elongated plate 11. The adjusting member 14 has a second affix fringe 142 corresponding to the first affix fringe 112, and the elongated plate 11 further has two toothed slots 113 defined on two sides of the top thereof, the adjusting member 14 further has two toothed defining blocks 143 arranged on a bottom thereof and corresponding to the two toothed slots 113, such that the adjusting member 14 retains with the two toothed slots 113 of the elongated plate 11. In addition, the adjusting member 14 is pulled so that the two toothed defining blocks 143 remove from the two toothed slots 113 of the elongated plate 11, thus adjusting and positioning the adjusting member 14 on the elongated plate 11. Preferably, between the second affix fringe 142 of the adjusting member 14 and the first affix fringe 112 of the elongated plate 11 defines a receiving space for accommodating the drilling tools of various sizes. The elongated plate 11 of the body 10 further includes at least one mounting set configured to mount the elongated plate 11 and the pad 12 of the body 10 on a working face. In this embodiment, the elongated plate 11 of the body 10 has two mounting sets 15, each mounting set 15 is mounted on each of two ends of the elongated plate 11 and has a sucker 151 and a rotating lever 152 connected with the sucker 152 and configured to control an attachment of the sucker 151 on the working face. The elongated plate 11 of the body 10 further has an inlet 114 defined on the top thereof, and the pad 12 further has a channel 122 defined therein and communicating with the inlet 114 of the elongated plate 11 and the second groove 121 of the pad 12. The accommodation case 20 is configured to accommodate coolant and includes an outlet 201 formed on a first end thereof, the accommodation case 20 also includes a cover 21 arranged on a second end thereof, and the cover 21 has an air hole 211 defined thereon. Between the accommodation case 20 and the elongated plate 11 of the body 10 defines a connection structure so as to connect the accommodation case 10 with the elongated plate 11, and the outlet 201 of the accommodation case 20 aligns with the inlet 114 of the elongated plate 11, the coolant flows into the channel 122 of the pad 12 from the accommodation case 20 via the outlet 201 and the inlet 114 of the elongated plate 11 and feeds into the second groove 121 from the channel 122 so as to cool the drilling tools. In this embodiment, between the accommodation case 20 and the connection structure of the elongated plate 11 defines a retaining rib 202 on a peripheral side of the accommodation case 20, the elongated plate 11 further has two locking recesses 115 formed on the top thereof so as to retain with the retaining rib 202 of the accommodation case 20, such that the accommodation case 20 contacts with the top of the elongated plate 11, and the outlet 201 of the accommodation case 20 aligns with the inlet 114 of the elongated plate 11, the coolant flows into the channel 122 of the pad 12 from the accommodation case 20 via the outlet 201 and the inlet 114 of the elongated plate 11 and feeds into the second groove 121 from the channel 122 so as to cool the drilling tools. Between an edge of the first end of the accommodation case 20 and the peripheral side of the accommodation case 20 defines a tilted angle, when the edge of the first end of the accommodation case 20 contacts with the top of the elongated plate 11, the accommodation case 20 tilts retentive to the elongated plate 11, and between the peripheral side of the accommodation case 20 and the top of elongated plate 11 defines an angle θ which is within 0 degree to 90 degrees, thus avoiding interference of the drilling tools and a driving tool in a drilling process. The accommodation case 20 has an engagement protrusion 203 fixed on the peripheral side thereof away from the retaining rib 202 so as to engage with the two locking recesses 115 of the elongated plate 11, and when the accommodation case 20 is in connection with the elongated plate 11, a connection size of the body 10 and the accommodation case 20 reduces, thus storing the body 10 and the accommodation case 20 easily.

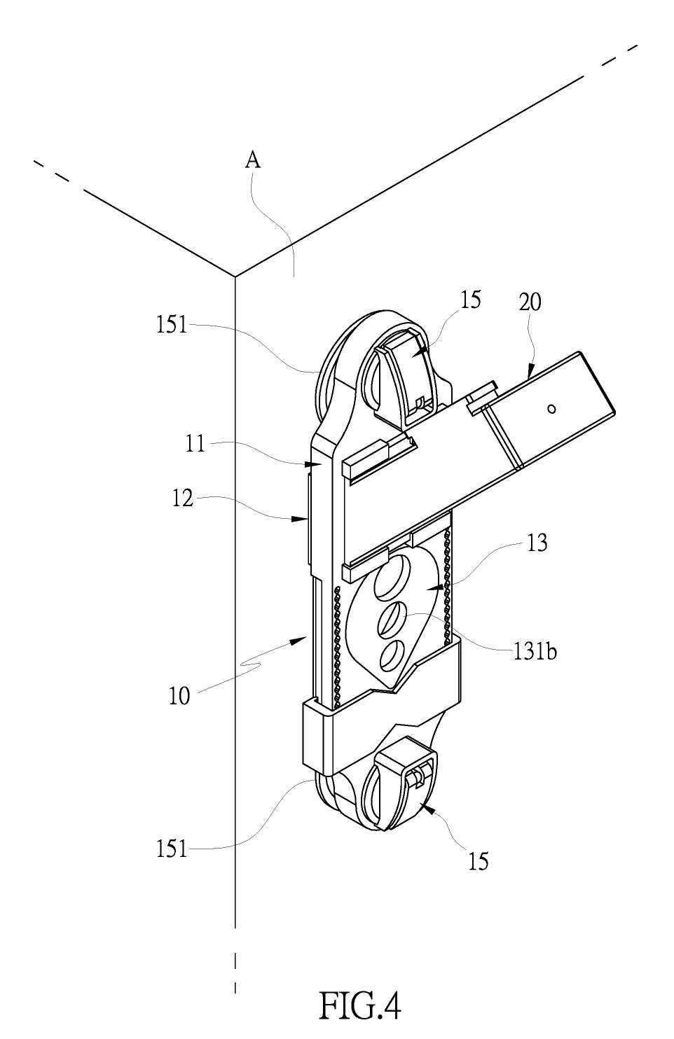

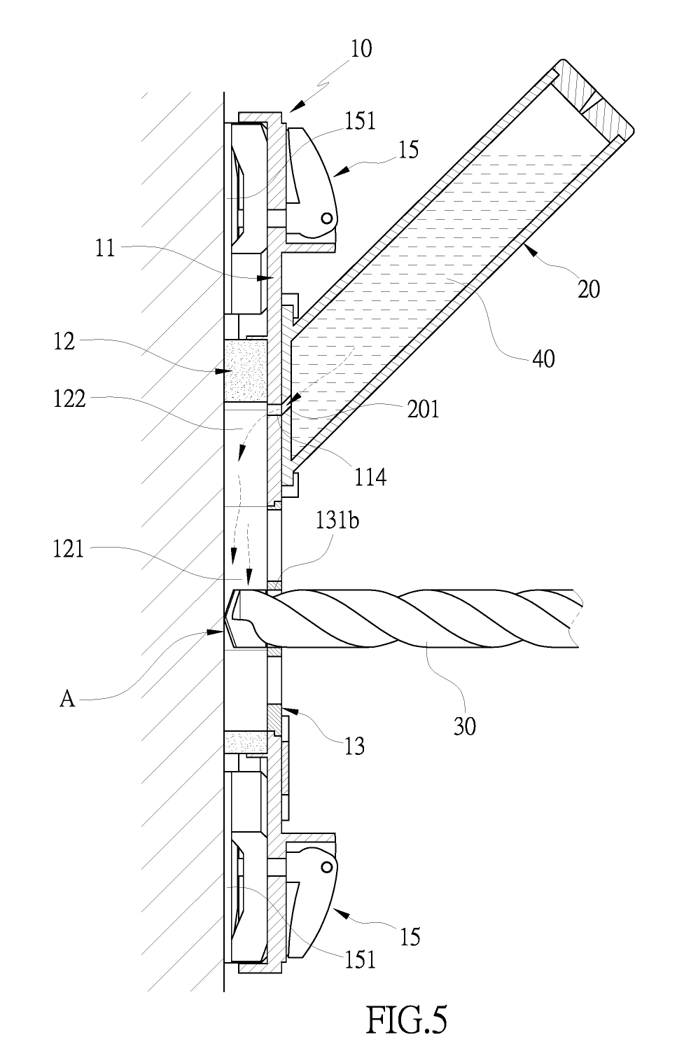

Referring to FIGS. 4 and 5, in operation, the first positioning structure or the second positioning structure of the body 10 is selected based on a drilling tool of a desired size. Taking a drilling tool 30 for example, it's size corresponds to a diameter of an orifice 131b of the fixing piece 13, and the body 10 is placed on the working face A so that the orifice 131b of the fixing piece 13 aligns with a drilling position of the working face A, and the sucker 151 of said each mounting set 15 sucks the working face A so that the body 10 positions on the drilling position of the working face A. The accommodation case 20 accommodates the coolant 40 so that when the drilling tool 30 inserts into the locating orifice 131b of the fixing piece 13, the locating orifice 131b of the fixing piece 13 fixes the drilling tool 30, and the drilling tool 30 drills at least one opening on the working face A. Preferably, the coolant 40 flows into the channel 122 of the pad 12 from the accommodation case 20 via the outlet 201 and the inlet 114 of the elongated plate 11 and feeds into the second groove 121 from the channel 122 so as to cool the drilling tool 30 efficiently.

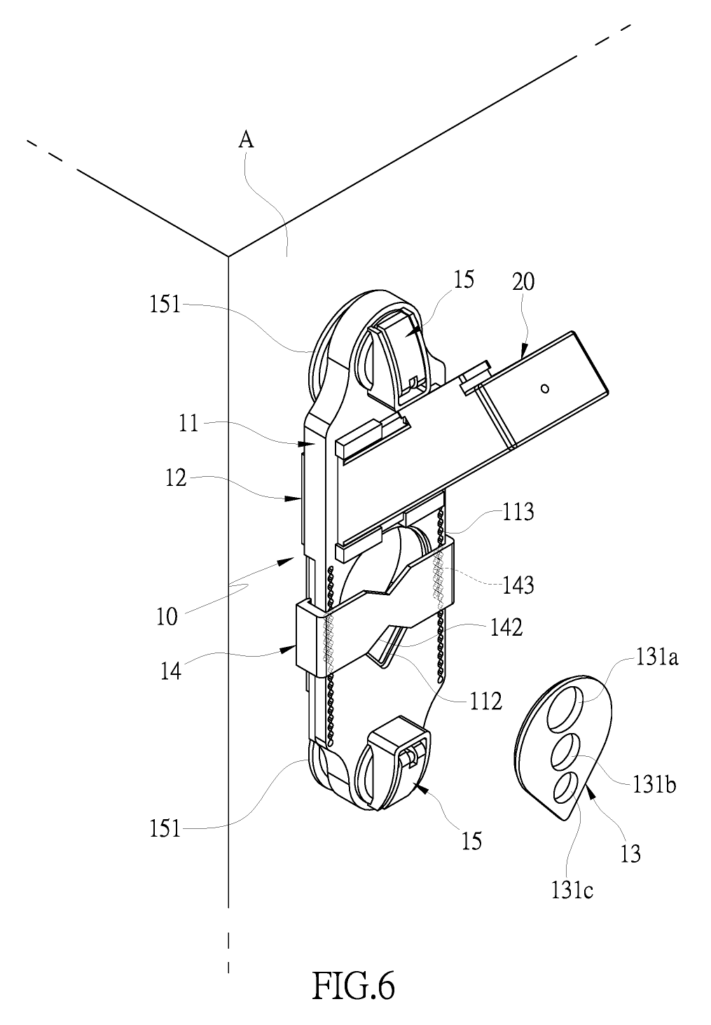

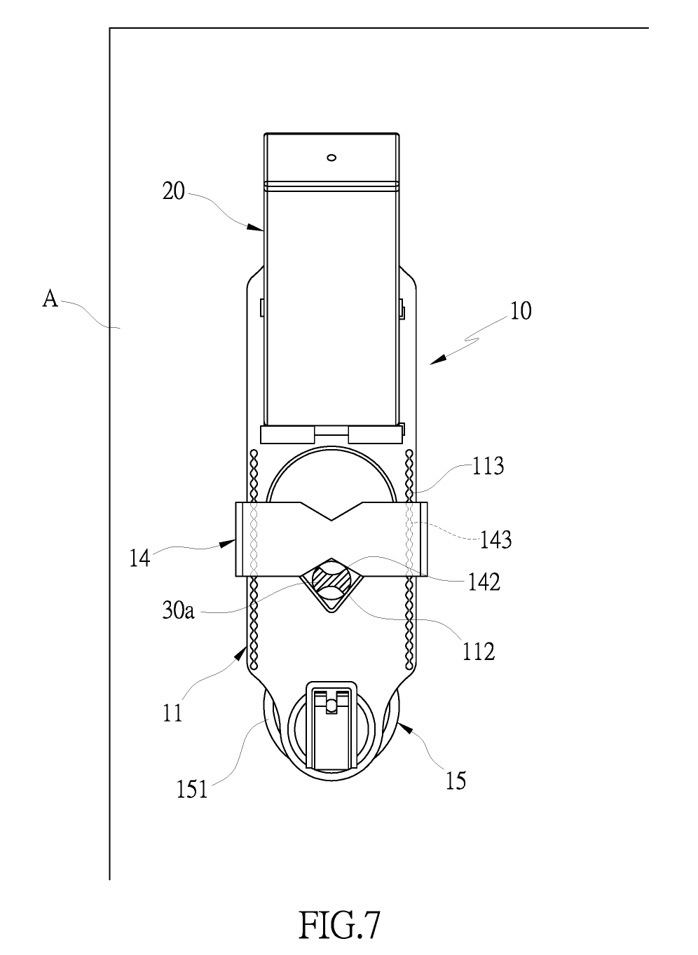

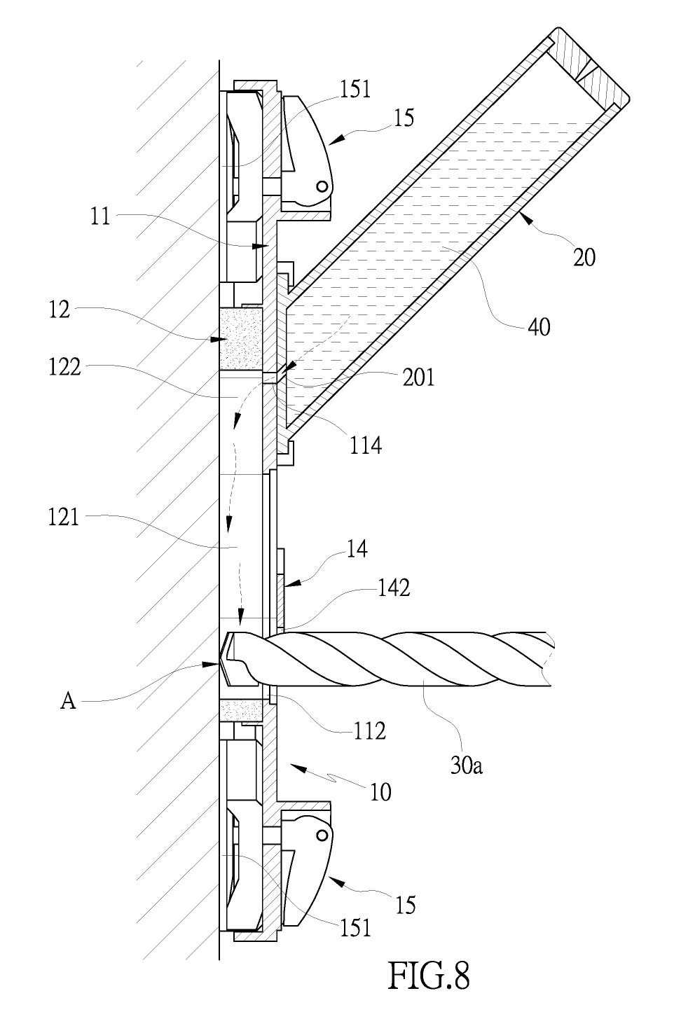

As shown in FIGS. 6 to 8, when a size of a drilling tool 30a does not correspond to a diameter of each of plural locating orifices 131a, 131b, and 131c, the fixing piece 13 is removed from the first groove 111 of the elongated plate 11, and the adjusting member 14 is adjustably moved on the top of the elongated plate 11, hence between the second affix fringe 142 of the adjusting member 14 and the first affix fringe 112 of the elongated plate 11 defines a receiving space configured to correspond to the drilling tool 30a and to align with a drilling position of the working face A, and the sucker 151 of said each mounting set 15 sucks the working face A so that the body 10 positions on the drilling position of the working face A. Thereafter, the drilling tool 30a inserts into the receiving space defining between the second affix fringe 142 of the adjusting member 14 and the first affix fringe 112 of the elongated plate 11, hence the drilling tool 30a drills at least one opening on the working face A. Preferably, the coolant 40 flows into the channel 122 of the pad 12 from the accommodation case 20 via the outlet 201 and the inlet 114 of the elongated plate 11, and the coolant 40 feeds into the second groove 121 from the channel 122 so as to cool the drilling tool 30a efficiently.

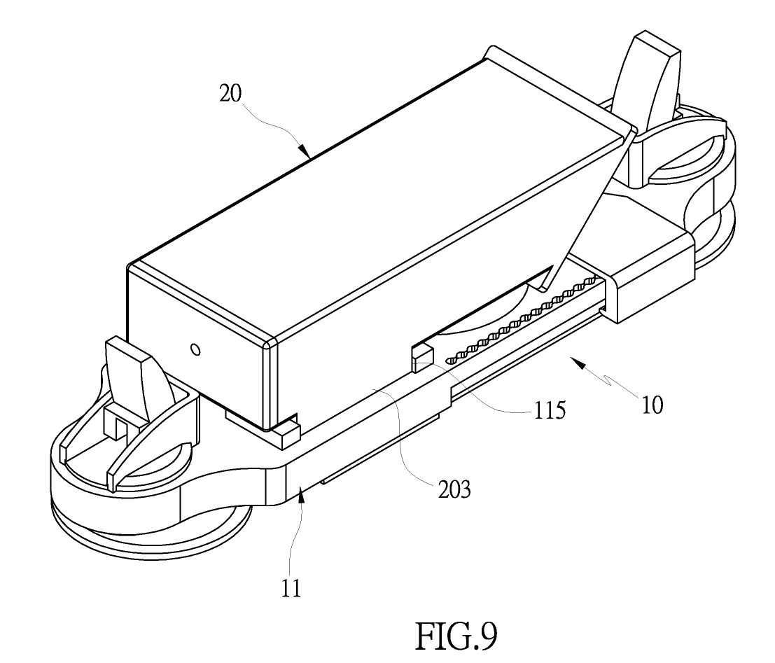

With reference to FIG. 9, the engagement protrusion 203 of the accommodation case 20 engages with the two locking recesses 115 of the elongated plate 11, and when the accommodation case 20 is in connection with the elongated plate 11, the connection size of the body 10 and the accommodation case 20 reduces, thus storing the body 10 and the accommodation case 20 easily.

While the preferred embodiments of the invention have been set forth for disclosure, modifications of the disclosed embodiments of the invention as well as other embodiments thereof may occur to those skilled in the art. Accordingly, the appended claims are intended to cover all embodiments which do not depart from the spirit and scope of the invention.

1. A positioning device for drilling tools of various sizes comprising:
a body including an inserting portion with at least one positioning structure configured to insert drilling tools of various sizes, the body also including at least one mounting set configured to mount the body on a working face, the body further including an inlet defined on a top thereof, and the body including a channel defined in a bottom thereof and communicating with the inlet and the inserting portion;
an accommodation case configured to accommodate coolant and including an outlet formed on a first end of the accommodation case, an air hole arranged on a second end of the accommodation case, a first peripheral side located adjacent to a top of an elongated plate on the body, and a second peripheral side located away from the top of the elongated plate and opposite to the first peripheral side of the accommodation case, wherein when an edge of the first end of the accommodation case contacts with the top of the elongated plate, the first peripheral side of the accommodation case tilts retentive to the top of the elongated plate on the body, the first peripheral side of the accommodation case does not contact with the top of the elongated plate, and between the first peripheral side of the accommodation case and the top of elongated plate defines an angle θ which is within 0 degree to 90 degrees;
a connection structure defining between the accommodation case and the body to connect the accommodation case with the elongated plate and to align the outlet of the accommodation case with the inlet of the body.

2. The positioning device for the drilling tools of various sizes as claimed in claim 1, wherein the body includes an elongated plate and a pad disposed on a bottom of the elongated plate and made of foam or rubber.

3. The positioning device for the drilling tools of various sizes as claimed in claim 2, wherein the elongated plate has a first groove defined on a central position thereof, and the pad has a second groove for corresponding to the first groove of the elongated plate, such that between the first groove of the elongated plate and the second groove of the pad defines an inserting portion so as to insert the drilling tools of various sizes.

4. The positioning device for the drilling tools of various sizes as claimed in claim 3, wherein the elongated plate of the body has the inlet defined on a top thereof, and the pad has a channel defined therein and communicating with the inlet of the elongated plate and the second groove of the pad.

5. The positioning device for the drilling tools of various sizes as claimed in claim 3, wherein the inserting portion of the body includes a first positioning structure, and the first positioning structure includes a fixing piece housed in the first groove of the elongated plate, and the fixing piece has plural locating orifices which correspond to the drilling tools of various sizes.

6. The positioning device for the drilling tools of various sizes as claimed in claim 3, wherein the inserting portion of the body includes a second positioning structure, and the second positioning structure includes a first affix fringe formed in a V shape and around a peripheral side of the first groove of the elongated plate, and the elongated plate also has an adjusting member mounted on the top thereof, wherein the adjusting member has two hooking portions, each hooking portion is arranged on each of two sides of the adjusting member so as to hook each of two sides of the elongated plate of the body, hence the adjusting member is adjustably moved on the top of the elongated plate, the adjusting member has a second affix fringe corresponding to the first affix fringe, and the elongated plate further has two toothed slots defined on two sides of the top thereof, the adjusting member further has two toothed defining blocks arranged on a bottom thereof and corresponding to the two toothed slots, such that the adjusting member retains with the two toothed slots of the elongated plate.

7. The positioning device for the drilling tools of various sizes as claimed in claim 1, wherein each mounting set has a sucker and a rotating lever connected with the sucker and configured to control an attachment of the sucker on the working face.

8. The positioning device for the drilling tools of various sizes as claimed in claim 1, wherein the accommodation case also includes a cover arranged on the second end thereof, and the cover has the air hole defined thereon.

9. The positioning device for the drilling tools of various sizes as claimed in claim 1, wherein between the accommodation case and the connection structure of the elongated plate defines a retaining rib on the peripheral side of the accommodation case, the elongated plate further has two locking recesses formed on the top thereof so as to retain with the retaining rib of the accommodation case, and the accommodation case contacts with the top of the elongated plate.

10. The positioning device for the drilling tools of various sizes as claimed in claim 9, wherein the accommodation case has an engagement protrusion fixed on the peripheral side thereof away from the retaining rib so as to engage with the two locking recesses of the elongated plate.
